(19) United States
(12) Patent Application Publication
(10) Pub. No.: US 2026/0187430 A1
(43) Pub. Date: Jul. 2, 2026

(54) METHOD AND DEVICE OF BIT-SHIFT AND PARSING-BASED QUANTIZATION FOR ELIMINATING FLOATING-POINT AND DIVISION OPERATIONS FOR EFFICIENT POST-TRAINING QUANTIZATION

(71) Applicants: Korea Advanced Institute of Science and Technology, Daejeon (KR); University-Industry Cooperation Group of Kyung Hee University, Gyeonggi-do (KR)

(72) Inventors: Minkyu JE, Daejeon (KR); Donghyeon YI, Daejeon (KR); SeoYoung LEE, Daejeon (KR); Jongho KIM, Daejeon (KR); Junyoung KIM, Daejeon (KR); Ik-Joon CHANG, Gyeonggi-do (KR)

(73) Assignees: Korea Advanced Institute of Science and Technology, Daejeon (KR); University-Industry Cooperation Group of Kyung Hee University, Gyeonggi-do (KR)

(21) Appl. No.: 19/437,051

(22) Filed: Dec. 30, 2025

(30) Foreign Application Priority Data
Dec. 31, 2024 (KR) 10-2024-0201533
Dec. 2, 2025 (KR) 10-2025-0188124

(51) Int. Cl. G06N 3/0495

(52) U.S. Cl. CPC G06N 3/0495

(57) ABSTRACT

Disclosed are a method and a device for bit-shift and parsing-based quantization for eliminating floating-point and division operations for efficient post-training quantization (PTQ), which may be configured to detect a bit of a position at which a value varies in a bitstring of a plurality of input values that are input in a bit-serial form as an effective most significant bit (eMSB), to define a parsing section of a target bit count based on the effective most significant bit, and to perform post-training quantization (PTQ) by applying arithmetic shift to the parsing section.

### CROSS-REFERENCE TO RELATED APPLICATION(S)

This application claims the priority benefit of Korean Patent Application Nos. 10-2024-0201533, filed on Dec. 31, 2024, and 10-2025-0188124, filed on Dec. 2, 2025, in the Korean Intellectual Property Office, the disclosure of which is incorporated herein by reference.

### BACKGROUND

### 1. Field of the Invention

The present disclosure relates to a method and a device for bit-shift and parsing-based quantization for eliminating floating-point and division operations for efficient post-training quantization (PTQ).

### 2. Description of the Related Art

Transformer models have built based on the attention mechanism, and have become fundamental in machine learning in various fields. While decoder-based architectures used in chatbot services have gained substantial attention, encoder-based models, such as bidirectional encoder representations from transformer (BERT) and vision transformer (ViT), remain critical for many tasks. However, the encoder-based transformers process entire input sequences within their self-attention layers. Due to this processing characteristic, as the sequence length increases, the computational intensity and intermediate memory traffic quadratically grow. This poses a significant challenge in efficiently processing the encoder-based transformers particularly in edge devices.

Analog-mixed-signal process-in-memory (AMS-PiM) has emerged as a promising solution to address these challenges. This is because AMS-PiM may efficiently execute basic linear algebra subprograms (BLAS) operations (level-2 and level-3, primarily matrix multiplication operations) within memory. Since these BLAS operations represent a significant portion of self-attention layers, AMS-PiM is highly effective for reducing off-chip data movement and energy consumption. However, the effectiveness of AMS-PiM does not extend to non-BLAS tasks, such as quantization processes, nonlinear layer computations, and normalization, requiring additional hardware and computational support. Concurrently, most AMS-PiM architectures rely on integer quantization required for attention operations in transformers. Various factors of transformers, for example, weights for query (Q), key (K), value (V), and projections (O), input embedding, Q/K/V values, attention score, and final output, all use quantized integer representations. Despite recent research on low-precision floating-point quantization methods, AMS-PiM is inefficient since FP-based exponent alignment is essential, and may not be used since the accuracy is significantly degraded if alignment is omitted.

Quantization-aware training (QAT) and post-training quantization (PTQ) are two primary approaches for quantization. QAT is widely adopted in AMS-PiM. QAT optimizes area/energy efficiency by enabling direct quantization with low-effective number of bits (ENOB) analog-to-digital converters (ADCs). Through retraining, QAT allows models to adapt to characteristics of ADCs and integer-approximated nonlinear layers, eliminating the need for a dequantization-quantization (DQ-Q) process and a floating-point unit (FPU). However, since QAT needs to retrain large-scale transformer models, cost is very large and increasingly impractical. Therefore, PTQ is gaining attention since, unlike QAT, PTQ may quantize models without retraining.

However, PTQ contains the following three major constraints in AMS-PiM: reliance on high-ENOB ADCs, susceptibility to process, voltage, temperature (PVT) variations, and the need for FPUs. Typically, PTQ requires a precise partial sum and a scaling factor to maintain accuracy for transformer models with large embedding depths (≥1 k) and high bit-precision requirements (≥4 bits per activation and weight). This demand requires ADCs with ENOB of 18 bits or more to prevent quantization errors since PTQ lacks the adaptability of QAT to lower-ENOB ADCs through retraining. Although it is not impossible to attempt PTQ with low-ENOB ADCs, it may result in excessive latency bottleneck since immense computational cycles are required from segmenting computations into smaller units. On the other hand, the main concern of high-ENOB ADCs is that they exacerbate hardware inefficiency. Their area and power consumption scale exponentially increases with 2^{ENOB}. As the ENOB increases, the sensing margin becomes narrower, which makes the system more vulnerable to errors caused by PVT variations. Also, since PTQ relies on accurate scaling factors during a DQ-Q process, FPUs are required to avoid cumulative rounding errors and to handle division operations, which leads to increasing system complexity.

Furthermore, nonlinear layer processing for PTQ introduces additional challenges. Integer-based approximation techniques for nonlinear functions and normalization layers effectively work in QAT-based systems, but often lead to significant computation deviations when they are applied to PTQ. As a result, PTQ relies on the DQ-Q process and FPUs to ensure accurate nonlinear layer processing. This dependency further increases system complexity and overhead.

### SUMMARY

To address the aforementioned challenges, the present disclosure proposes a novel analog-mixed-signal process-in-memory (AMS-PiM) architecture that comprehensively addresses the inefficiency of PTQ. The present disclosure implements PTQ and integer-based nonlinear layer processing that may eliminate a high-effective number of bits (ENOB) analog-to-digital converter (ADC), a division operation, and a floating-point unit (FPU) and, at the same time, does not require dequantization. Also, the present disclosure enables fast, error-tolerant, and efficient computation through a sparse general matrix vector (GEMV) operation using low-ENOB ADC-based bitwise sparsity. In addition, the present disclosure realizes on-device end-to-end kernel fusion by closely analyzing the overall attention operation.

In summary, the present disclosure achieves the followings: reducing quadratic off-chip tensor traffic through end-to-end on-chip processing of self-attention layers; integer (INT)-only, dequantization-free PTQ and nonlinear-layer processing to maintain precision without a high-ENOB ADC, a division, or an FPU; and fast, accurate, and efficient sparse GEMV operation with 6-σ confidence by utilizing low-ENOB ADCs within MRAM-SRAM hybrid AMS-PiM arrays. These advancements provide a scalable and energy-efficiency solution for transformer inference, particularly, effectively addressing the distinct inference time bottleneck of encoder-based models.

Accordingly, the present disclosure provides a method and a device for bit-shift and parsing-based quantization for eliminating floating-point and division operations for efficient post-training quantization (PTQ).

The present disclosure provides an operating method of a computing device, and the operating method of the computing device may include detecting a bit of a position at which a value varies in a bitstring of a plurality of input values that are input in a bit-serial form as an effective most significant bit (eMSB); defining a parsing section of a target bit count based on the effective most significant bit; and performing post-training quantization by applying arithmetic shift to the parsing section.

The present disclosure provides a computing device, and the computing device may include a memory; and a processor configured to connect to the memory, and to execute at least one instruction stored in the memory, wherein the processor may be configured to detect a bit of a position at which a value varies in a bitstring of a plurality of input values that are input in a bit-serial form as an effective most significant bit, to define a parsing section of a target bit count based on the effective most significant bit, and to perform post-training quantization by applying arithmetic shift to the parsing section.

The present disclosure provides a non-transitory computer-readable recording medium storing a computer program to execute a post-training quantization method on a computing device, wherein the post-training quantization method may include detecting a bit of a position at which a value varies in a bitstring of a plurality of input values that are input in a bit-serial form as an effective most significant bit; defining a parsing section of a target bit count based on the effective most significant bit; and performing post-training quantization by applying arithmetic shift to the parsing section.

The present disclosure may achieve dequantization-quantization, that is, fake-quantization removal and increased hardware efficiency. eMSB-Q may eliminate the conventional quantization, that is, dequantization-quantization process, and may perform operations through eMSB detection, arithmetic shifting, and parsing. Through this, by eliminating reliance on an FPU and a high-ENOB ADC, complexity and power consumption of hardware design may be significantly reduced.

The present disclosure may ensure high accuracy by maintaining a numerical ratio. By implementing quantization that maintains a ratio based on eMSB of input data, precision with the same ratio as floating-point (FP)-based quantization may be provided. Using an additional bit in this process may guarantee numerical stability while maintaining computational accuracy.

The present disclosure enables efficient computation through bitwise sparsity. eMSB-Q may maximize the computational efficiency by processing data at the bit level. In particular, by effectively utilizing bitwise sparsity that frequently occurs in a deep neural network (DNN), it is possible to reduce a required computational amount and to increase a speed.

The present disclosure may maintain exponent information of a nonlinear layer. eMSB-Q may efficiently maintain exponent information required in a nonlinear layer (e.g., softmax) and may replace divisions with arithmetic shifting. This may minimize hardware burden while maintaining the existing computational accuracy.

The present disclosure may demonstrate improved robustness against process, voltage, temperature (PVT) errors. eMSB-Q is designed with low-ENOB instead of using a high-ENOB ADC, thereby reducing computational errors due to PVT variations and providing a stable computational environment.

The present disclosure may provide a design optimized for a transformer model. It may generate core operations (e.g., query/key/value (Q/K/V)) of a transformer-based model, may perform direct operations with quantized data in self-attention, and may improving energy efficiency while maintaining model accuracy.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates the design of a typical process-in-memory (PiM);

FIG. 2 illustrates the attention mechanism of a transformer model;

FIGS. 3A, 3B, and 3C illustrate an example of quantization;

FIG. 4 illustrates reduced sensing margin of analog-mixed-signal (AMS)-PiM using high-effective number of bits (ENOB) analog-to-digital converters (ADCs);

FIGS. 5A, 5B, 5C, 5D, 5E, and 5F illustrate comparison of sparsity measured in various granularity;

FIG. 6 illustrates the overall FLARE architecture according to the present disclosure;

FIGS. 7A and 7B illustrate attribute and size requirements of each memory type in the FLARE architecture and results of Monte-Carlo-simulation-guided SAWL selection for lossless computation according to the present disclosure;

FIGS. 8A, 8B, and 8C illustrate a floating-point (FP)- and division-less integer quantization method according to the present disclosure;

FIG. 9 illustrates a VDR-softmax implementation algorithm according to the present disclosure;

FIGS. 10A and 10B illustrate a SAWL_{D} controller according to the present disclosure;

FIG. 11 illustrates a BitShift-GEMV controller according to the present disclosure;

FIG. 12 illustrates FLARE data flow and tensor traffic according to the present disclosure;

FIG. 13 is a diagram illustrating a computing device according to the present disclosure; and

FIG. 14 is a flowchart illustrating an operating method of a computing device according to the present disclosure.

### DETAILED DESCRIPTION

The present disclosure provides a method and a for bit-shift and parsing-based quantization for eliminating floating-point and division operations for efficient post-training quantization (PTQ). In the following, quantization specifically refers to an “integer quantization” process of converting a number with floating-point (FP) or long representation (integer of >n bits) to an n-bit integer among a plurality of techniques of making a number representation system lightweight. Integer quantization is performed through the following process: determine a maximum value of a bundle of input numbers (input_{MAX}), and perform a sorting algorithm to find which value is exactly largest; accurately identify the maximum value (input_MAX) and then divide the number by 2ⁿ to acquire a scaling factor (S=input_{MAX}/2ⁿ), and in this process, handle FP-based division since it is important to acquire error-free S through accurate division for post-training quantization (PTQ), which requires large energy/area in hardware; and perform quantization by dividing input bundle values by S (, which requires a floating-point unit again) and then rounding them to integer.

The present disclosure is designed to effectively utilize a bit-level computation processing technique in an analog-mixed-signal environment to achieve an accurate and energy/area efficient quantization technique and to provide high performance even in application environments with large-scale data processing and energy constraints. In particular, the present disclosure proposes the architecture that may support high computational accuracy while eliminating floating-point processing and division processing, which are considered essential for accurate partial sum and division operations suitable for post-training quantization (PTQ), and may maintain precision while significantly improving computational efficiency compared to existing technology.

Hereinafter, the present disclosure is described in more detail with reference to the accompanying drawings.

### 1. Background

### (1) Analog-Mixed-Signal Process-In-Memory (AMS-PiM)

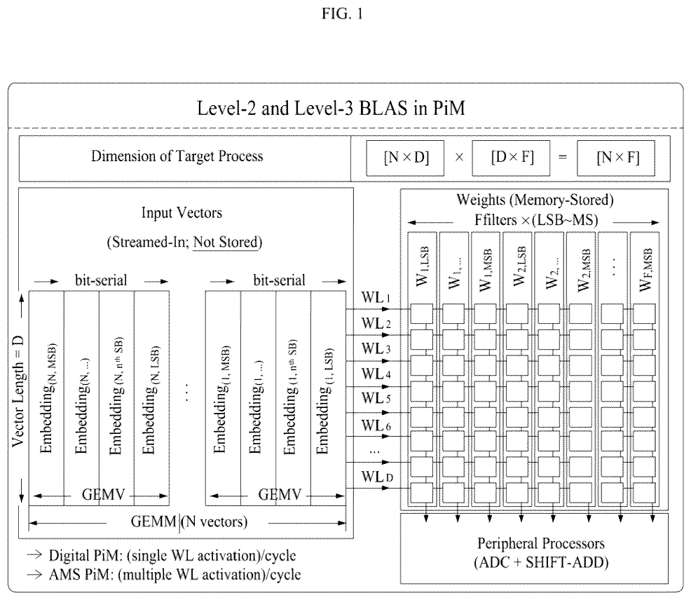

FIG. 1 illustrates the design of a typical process-in-memory (PiM).

Referring to FIG. 1, the PiM architecture is widely evaluated as a structure that may inherently and efficiently execute level-2 (i.e., GEMV) and level-3 (i.e., GEMM) BLAS operations, which contribute to a major portion of most deep neural networks (DNNs). A PiM device executes operations by storing matrices in a memory array and by fetching vectors (which also form other matrices) along wordlines (WLs), bitlines (BLs), or sourcelines (SLs). In the illustrated configuration, weights of F filters are stored across the memory array, inputs of depth D are fed to WL_{1˜D} in a bit-serial manner for m-bit representation, and a partial sum for each bit position is generated in a BL. By directly executing BLAS operations within the memory, PiM significantly reduces latency according to data movement and energy overhead.

The AMS-PiM architecture, particularly, enhances the computational efficiency compared to a digital method. This may be achieved by simultaneously activating a plurality of memory interfaces, such as a WL, a BL, and an SL, and thereby executing multiple computations within a single memory array in parallel. In digital PiM, a single WL is activated per cycle to perform a column sum operation, that is, pop (“1” or “on-cell”)-count operation, which is similar to a conventional read operation. On the other hand, AMS-PiM may execute multiple operations in parallel by simultaneously activating a plurality of WLs and by converting an analog sum to a digital signal through an ADC.

### (2) Self-Attention Layer in Transformer Encoder

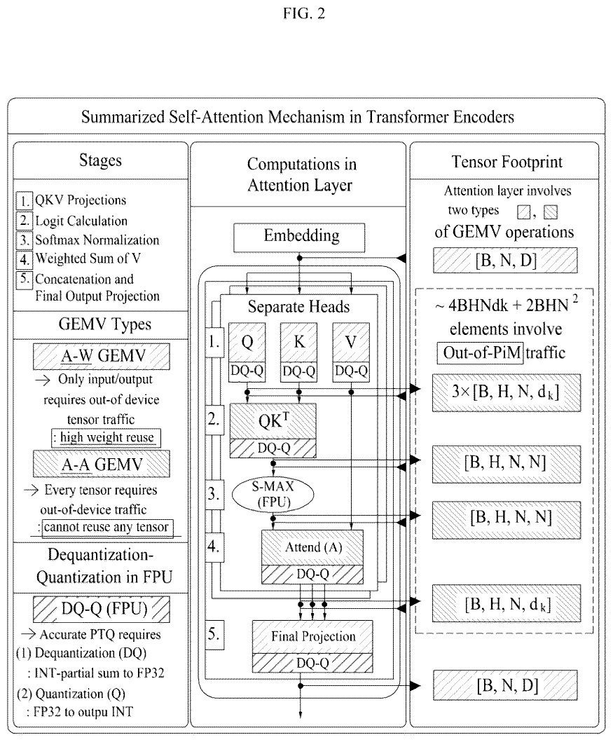

FIG. 2 illustrates the attention mechanism of a transformer model.

Referring to FIG. 2, self-attention includes a plurality of linear projection layers with two types of GEMV operations, and include, in between, softmax, dimensional adjustment (transpose and concatenation), and DQ-Q operations. However, unlike QAT, a DQ-Q process and nonlinear layers are combined in PTQ and create a deadlock between hardware overhead and tensor traffic.

In the attention mechanism in the transformer model, each token in input is represented as a vector of dimension D. Each of B input batches to a self-attention layer includes N tokens, resulting in an input tensor of dimension [B, N, D]. The input is processed through the attention mechanism with a plurality of stages as follows, and each stage contributes to the increase in tensor traffic.

\textcircled{1} QKV projections: An initial stage involves projecting each input sequence into three distinct weight matrices to generate query (Q), key (K), and value (V). These projections are computed using weight-stationary matrices W_{Q}, W_{K}, and W_{V} of dimension [D, dₖ]. Here, dₖ denotes a separate weight dimension per attention head. As a result, tensors Q=X·W_{Q}, K=X·W_{K}, and V=X·W_{V} are acquired, each with dimension of [B, N, dₖ] per head. When the number of attention heads H=D/dₖ, the dimension of each of Q, K, V tensors becomes [B, H, N, dₖ].

\textcircled{2} Log it calculation: The core of the attention mechanism is computing log it scores (L) by a dot product between query (Q) and key (K): L=Q·K^{T}. The dimension of a score tensor generated through this operation is [B, H, N, N]. This operation has quadratic complexity that requires O(N²d) operations per head, significantly contributing to the increase in tensor traffic and computational load.

\textcircled{3} Softmax normalization: The computed log its are scaled and passed through a softmax layer to normalize the summed score. This normalization process involves nonlinear operations, and causes tensor traffic of [B, H, N N].

\textcircled{4} Weighted sum of values: The normalized attention scores are used to compute a weighted sum of value (V) vectors, resulting in yielding an output tensor of dimension [B, H, N, dₖ].

\textcircled{5} Concatenation and final output projection: Finally, the outputs from all heads are concatenated and projected together once again, using a weight matrix (W_{O}) to produce the final output tensor of [B, N, D].

DQ-Q process and FPU: Not only nonlinear functions and accurate divisions required by softmax but also all operations of stages 1 to 5 of PTQ require the DQ-Q process. This process involves high-ENOB ADCs, division operations, and FPUs, and these requirements easily deteriorate the efficacy of PiM. This strongly implies a need to design a PiM-based accelerator that may alleviate these limitations.

### (3) Kernel Fusion and Self-Attention Inference Optimization

Unique characteristics of the self-attention mechanism have provided remarkable performance, however, also introduced quadratic computational load and memory traffic, prompting the development of various innovative techniques to alleviate these limitations. Similar to PTQ, the kernel (operation) fusion technique has been also proposed as technology that may effectively achieve the given goal without impacting the model inference accuracy. The kernel fusion combines operations involving massive intermediate tensor traffic, thereby reducing memory access overhead for these intermediate tensors.

When an on-device kernel fusion technique is not applied, the out-of-PiM for self-attention computations may be expressed as [Equation 1] below. As described above, a PiM device is only suited for processing BLAS layers on-device. Therefore, without adequate optimization, the kernel fusion with its inherent limitations, high-ENOB ADCs and FPUs, deteriorates the effectiveness of the PiM architecture.

$$Original ( Out - of - Device Tensor ) traffic \qquad [ Equation 1 ]$$

$$= B \times N \times D ( in ) + B \times N \times D ( out ) + 2 \times B \times H \times {N}^{2} + 4 \times B \times H \times N \times {d}_{k} ( in - and - out )$$

Therefore, the present disclosure proposes a novel quantization technique and a nonlinear layer processing technique, enabling end-to-end kernel fusion with low hardware overhead. The tensor traffic revised when the technique of the present disclosure is applied is expressed as [Equation 2] below. Through this, the existing quadratic O(N²) tensor traffic reduces to a linear O(N).

$$Revised Tensor Traffic = 2 \times B \times N \times D ( in ) + B \times N \times D ( out ) \qquad [ Equation 2 ]$$

### 2. Motivation

The present disclosure reveals that the effectiveness of the PiM architecture is notably hindered by high-ENOB ADCs and FPUs. Also, among various arithmetic operations required to execute self-attention, division arithmetic, not only in FP but also in an integer format, hinders hardware efficiency. Therefore, the optimization strategy of the present disclosure focuses on addressing this challenging overhead while preserving accuracy and performance, and also focuses on the following principles:

### Accurate Quantization

Lossless quantization: The technique of the present invention needs to accurately represent quantized values even without FP or division arithmetic.
Outlier preservation: Attention layers often generate channels with extreme outliers that standard integer quantization in PTQ may not capture well. To address this, the present disclosure applies token-wise quantization to accurately reflect these outliers.

### Accurate Nonlinear (Non-BLAS)-Layer Execution

A transformer model depends greatly on nonlinear layers that require complex exponentiation and division operations. The approach of the present disclosure preserves the exponential trend and proportional relationships between values without FP or division arithmetic.

### PVT-Robust and Error-Resilient AMS-PiM

Despite its high efficiency, AMS-PiM has frequently been criticized for computational errors due to PVT variations. However, the conventional design methods for solving the errors often conflict with the goal of efficiently utilizing the PiM device.
The technique of the present disclosure effectively resolves this fundamental dilemma.

### (1) Motivation for PTQ and Non-BLAS Layer Optimization

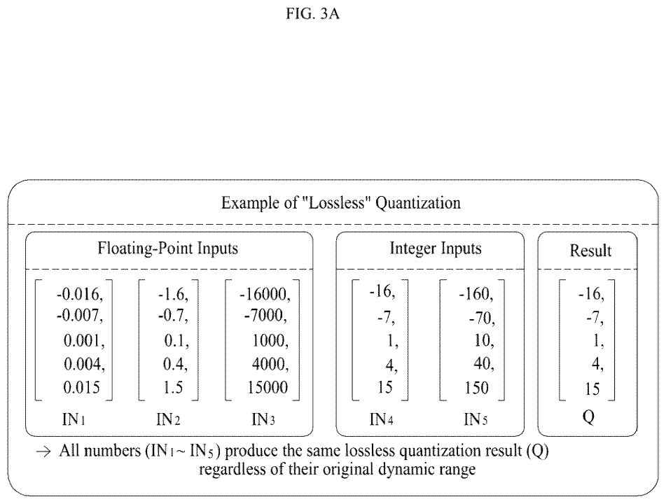

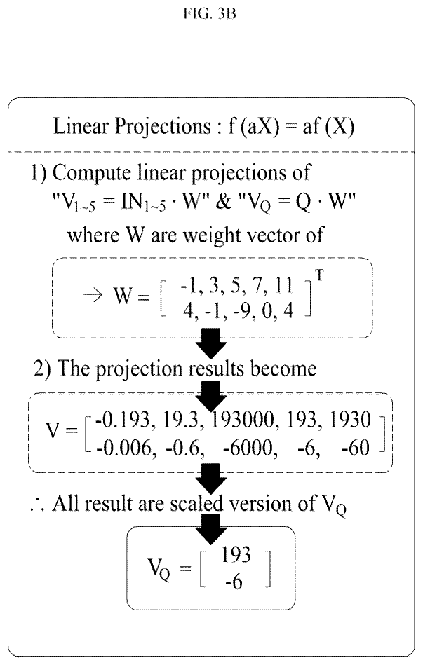

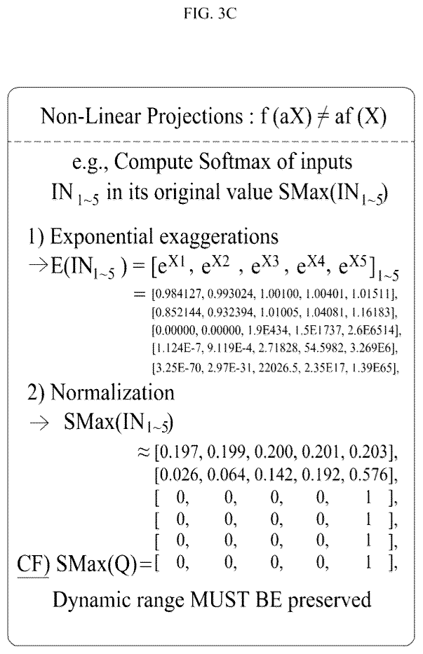

FIGS. 3A, 3B, and 3C illustrate an example of quantization.

Although all quantization techniques may not be covered herein, the basic stages for accurate and efficient quantization are as follows: \textcircled{1} identify a minimum value and a maximum value among give inputs (xᵢ∈X), \textcircled{2} for n-bit quantization, define a quantization step (S) by dividing the minimum-maximum range by 2ₙ levels, and \textcircled{3} divide each xᵢ by S to acquire quantized values.

In this process, as shown in FIG. 3A, when ratios between quantized values retain original proportions, the corresponding quantization is “lossless,” which is expressed as [Equation 3] below.

$$quantize ( {x}_{i} ) / quantize ( {x}_{j} ) \approx {x}_{i} / {x}_{j} , ∀ {x}_{i} , {x}_{j} ∈ X \qquad [ Equation 3 ]$$

However, although “lossless” quantization is achieved using FPUs, the original exponent information is not retained. Nonetheless, this exponent information loss issue as illustrated in FIG. 3B is less severe in linear projection operations since linear operations preserve their inherent quality even without exponent information. This is expressed as [Equation 4] below.

$$a \times f ( X ) = f ( a \times X ) \qquad [ Equation 4 ]$$

On the other hand, as illustrated in FIG. 3C, nonlinear layers are completely disrupted when exponent information is omitted. This is expressed as [Equation 5] below.

$$a \times f ( X ) \neq f ( a \times X ) \qquad [ Equation 5 ]$$

Recent studies attempt to ensure a certain level of reliability while replacing FP-based computations with integer-based simplified computations. However, this approach may reduce the accuracy of PTQ-based inference since a model may not adapt to these approximations without retraining.

In response thereto, section 3 of this document proposes an integrated quantization-computation method that preserves the exponent for nonlinear layers while replacing division operations only with parsing and bit-shifting. The existing studies introduced the idea of capturing a most significant bit (MSB)'s position using a parsing method. However, they rely on group-wise quantization, so have large storage overhead and limited scalability. In contrast, the method of the present disclosure fused token-wise quantization with VDR-softmax, temporarily stores only a single-token value in compact register, and discards the same after processing. Also, the method of the present disclosure designs the quantization process to link to and penetrate through end-to-end attribute of each stage in an attention layer.

### (2) Motivation for Accurate and Efficient AMS Computation

As described above, the transformer model with PTQ requires very high precision for a partial sum. In particular, when d_{model}≥1 k and activation/weight operand ≥4 bit, the partial sum precision is 18 bits or more. This high-precision summation for which direct quantization is difficult requires ADCs with high-ENOBs. This increases not only area/energy overhead but also the likelihood of errors.

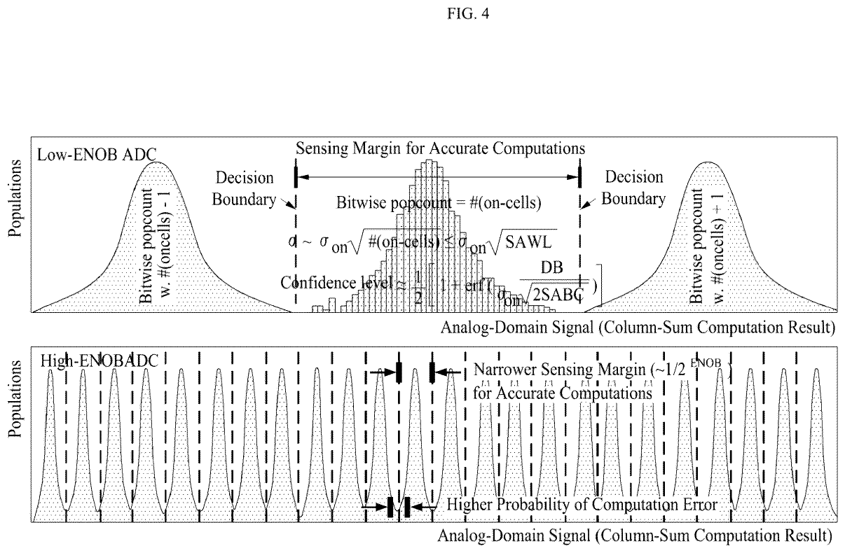

FIG. 4 illustrates reduced sensing margin of AMS-PiM using high-ENOB ADCs.

To ensure accurate analog computation in PTQ, the number of decision boundaries needs to exceed the number of distinct analog signal levels. This is a fundamental requirement in PTQ since accurate quantization relies on precise summation and digital conversion of analog values. However, achieving this narrows sensing margin of ADCs, which worsens error resilience, as illustrated in FIG. 4. Errors occur when analog signals cross decision boundaries during an analog-to-digital conversion process, and this challenge further increases as sensing margin narrows.

The computational error resilience, which leads to the technique of the present disclosure, may be analyzed as follows. As illustrated in FIG. 1, analog signals are proportional to the number of “on-cells” generating on-current within activated WLs. Recent studies show that reducing the number of activated “on-cells” in a partial sum process reduces error rates. Meanwhile, the number of simultaneously activated WLs (SAWL) determines the direct upper limit of the number of activated “on-cells” contributing the analog summation. Therefore, the number of activated “on-cells” may be controlled by limiting the SAWL, and reliability of computation may be enhanced by segmenting the computation unit with shorter input vectors. This approach reduces the required ADC ENOBs and lowers the area/power overhead of ADCs by 2^{ENOB}, thereby significantly relaxing the hardware complexity. Also, by integrating strategic computation segmentation reducing ADC overhead with an error mitigation technique described in section 3, the present disclosure may significantly improve PVT robustness.

(3) Massive GEMV with Quadratic Latency Bottleneck

As described above, to achieve the error-free analog computation, the maximum value of SAWL needs to be limited and computation needs to be executed over a plurality of cycles by segmenting input into sliced inputs (e.g., dividing D in FIG. 1 into D/N over N cycles). However, this slice-based processing method significantly increases processing cycles since the vector length is constrained. Here, the increase in the model size and the quadratic GEMV demand in the attention layer may further degrade the performance.

For example, a length (l)-restricted GEMM operation in which SAWL≤l=8 is assumed. Here, hidden dimension (D)=1024, the number of tokens (N)=512, 512 GEMV executions per batch, and 8-bit integer representation (Bit-Precision (BP)=8) for both input and weight. Processing each bit-serial vector of a token requires the following: D/l=1024/8=128 cycles. This is because each bit-serial part of an input token is partitioned into eight WL chunks to meet SAWL≤8. Therefore, the bitwise GEMV operation, requiring D/l (=128) cycles per bit, needs to be performed a total of N×BP=512×8=4,096 times, to process all GEMVs of bit vectors and tokens constituting GEMM. As a result, a total number of cycles required to process a single GEMM of an embedding input using static (weight-stationary) weight matrices is (D/l)×N×BP=524,288 cycles.

Assuming 10 ns per bitwise GEMV, it is a fast figure for an AMS-PiM array, but a GEMM operation for generating Q, K, or V takes about 0.5 milliseconds (ms). Here, involving activation-activation GEMV with quadratic computational complexity and nonlinear layers induces substantially greater latency, rendering the PiM device noncompetitive in terms of latency. As a result, the latency for processing linear projections across attention layers in tens of encoder blocks may be about in the order of tens of milliseconds (˜100 ms).

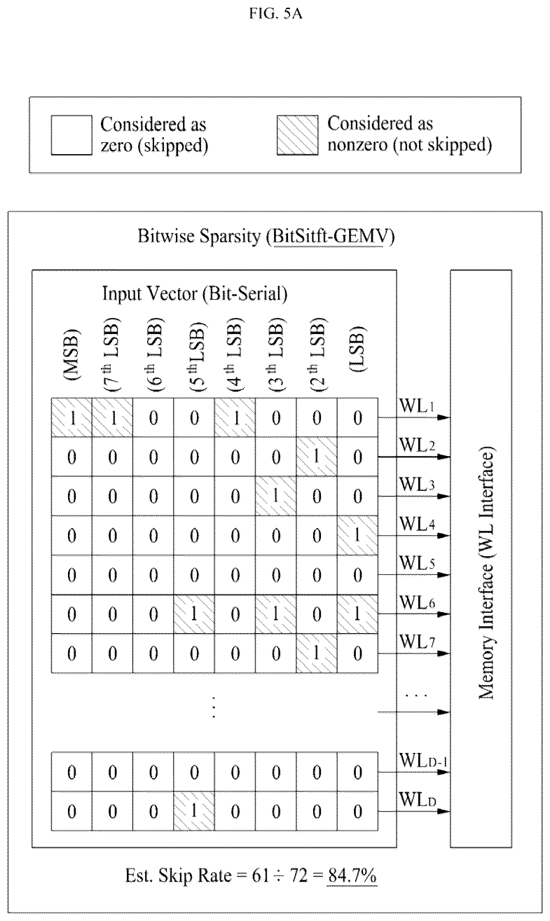

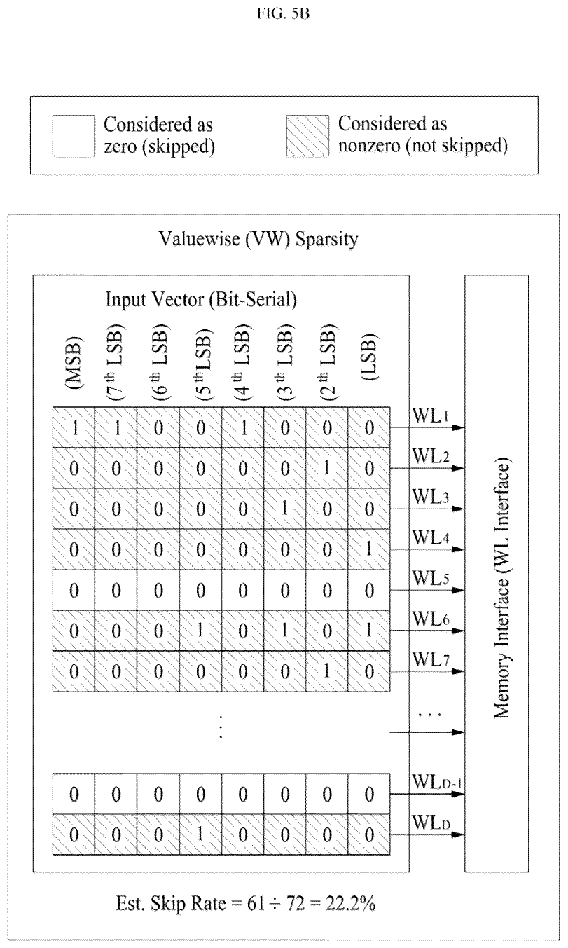

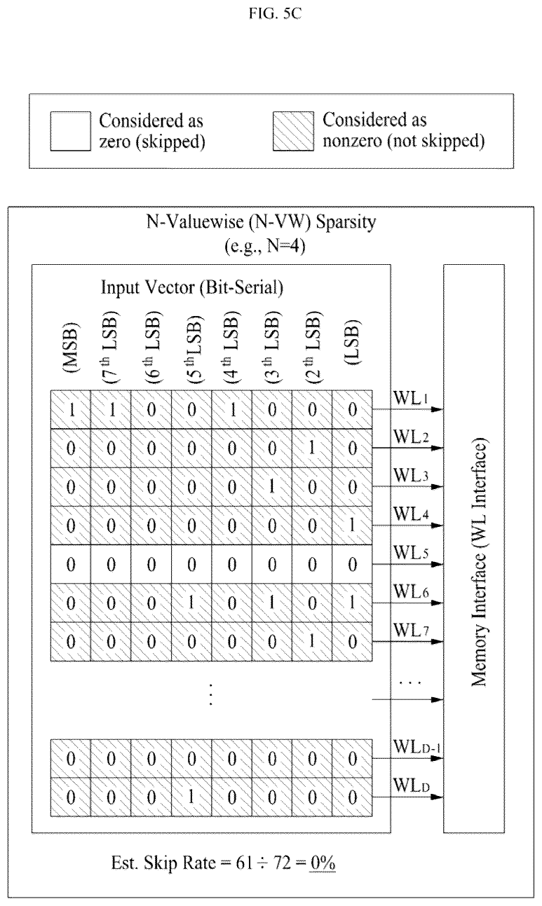

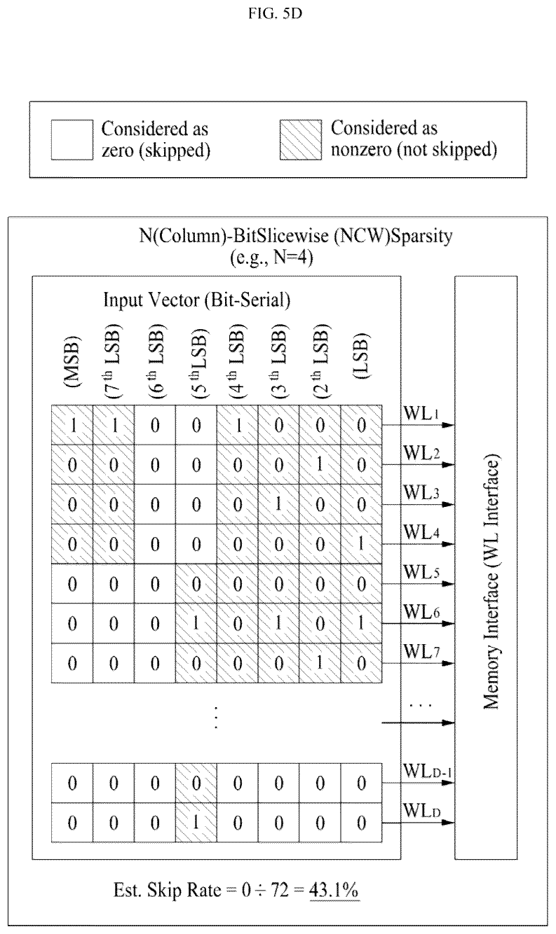

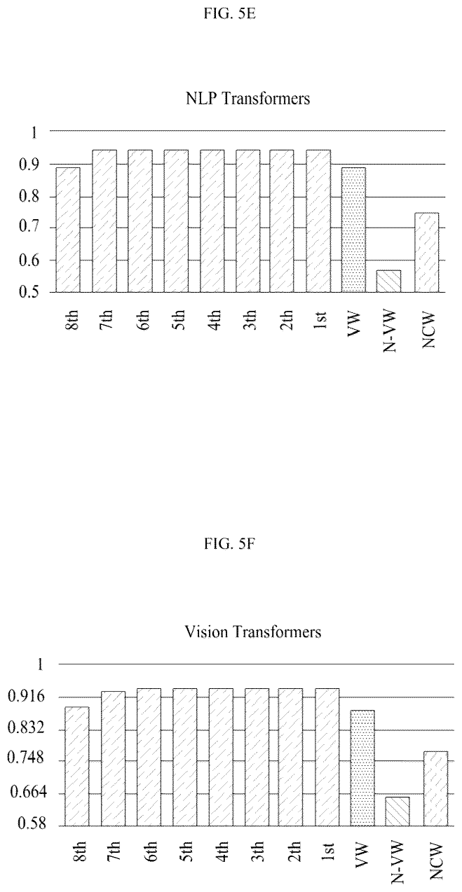

FIGS. 5A, 5B, 5C, 5D, 5E, and 5F illustrate comparison of sparsity measured in various granularity. Here, FIGS. 5A, 5B, 5C, and 5D visualize various types of sparsity appearing when the same 8-bit-integer vectors are input in a bit-serial manner. Sparsity is measured and utilized in the following manners: (a) bitwise manner, (b) valuewise (VW) manner (in which 8-bit integer includes complete “0”s), (c) N-valuewise (N-VW) manner, and (d) N-column-BitSlicewise (NCW) manner (when a part of bitwise input is all “0”s in column direction). The result of measuring averaging activation sparsity with input, Q, K, V, and output layers in transformer blocks is shown for NLP task in FIG. 5E and for vision task in FIG. 5F.

To address the latency issue, the high ‘bitwise sparsity’ of activation in bitwise GEMV of an attention layer is utilized. The analysis result suggests that collecting and processing only “1”s in bitwise embedding input may significantly improve the performance of GEMV and GEMM including GEMV. As visualized in FIGS. 5E and 5F, when splitting the input into bitwise elements (FIG. 5A), activation matrices exhibit much higher sparsity when measured on coarser value grains (FIGS. 5B, 5C, and 5D). Base on this observation, the present disclosure proposes BitSift-GEMV technique. In this technique, all items with a bit value of “0” among input activation values fetched in a bit-seral manner are skipped from GEMV operations within AMS-PiM arrays.

Section 3 proposes a hardware-oriented technique that determines the longest combination of parsed input slices, including the fixed number of “1”s. By parsing and merging bit-serial-fetched token vectors, the length of an input vector processible in a single GEMV may be significantly increased. Furthermore, the proposed technique maximizes the utilization efficiency of the designed ADC, and also improves the stability of ADC operation by limiting excessive flexibility

### 3. FLARE Architecture

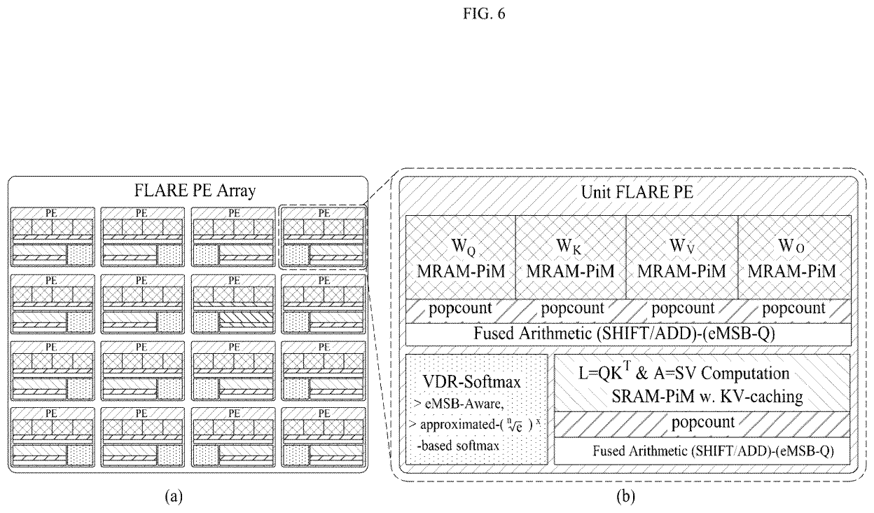

FIG. 6 illustrates the overall FLARE architecture according to the present disclosure.

Based on the aforementioned analysis and discussion, the present disclosure proposes the FLARE architecture, which is an FP- and division-less, end-to-end attention accelerator based on MRAM-SRAM hybrid AMS-PiM with low-ENOB ADCs. The proposed architecture ensures accurate, reliable, efficient, and fast on-device attention-layer computation, and is validated at the post-layout level using a 28 nm FD-SOI process.

### (1) MRAM-SRAM Hybrid AMS-PiM Design

The basement of the system of the present disclosure, the MRAM-SRAM hybrid AMS-PiM design, is configured to handle two distinct types of GEMVs, activation-weight (A-W) GEMV and activation-activation (A-A) GEMV, executed during a DNN's core operation, that is, a PIM-based BLAS acceleration process according to intrinsic advantages of each memory. The MRAM-PiM is suitable for A-W GEMV. This is because a weight may be repeatedly reused due to the non-volatile property of MRAM. Also, MRAM may maximize array-level parallelism due to a small memory cell size (about ⅓ of SRAM). Meanwhile, the A-A GEMV needs to dynamically convert both operands, so is handled using SRAM-PiM. SRAM offers high write speed and low write energy compared to MRAM, so is ideal for dynamic A-A GEMV execution.

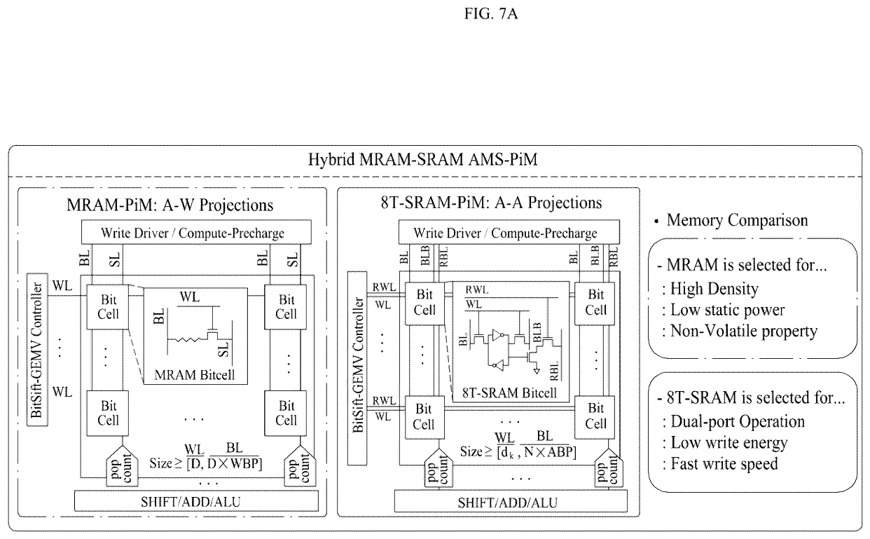

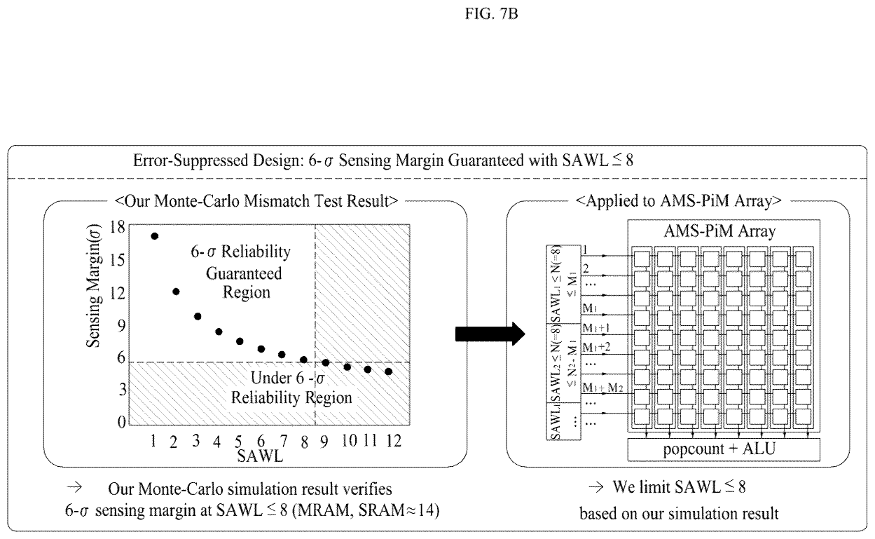

FIGS. 7A and 7B illustrate attribute and size requirements of each memory type in the FLARE architecture and results of Monte-Carlo-simulation-guided SAWL selection for lossless computation according to the present disclosure.

The size and the number of arrays are configured to fully encompass all parameters and computations of self-attention layers. This is a fundamental requirement for achieving the end-to-end acceleration of a target model. FIG. 7A describes the minimum array configuration requirements required to implement the FLARE architecture.

First, MRAM-CiM arrays for A-W GEMVs need to be able to store D² weight elements for each of query key value final-output projection layers. For each array, a total number of WLs needs to be greater than the hidden dimension D such that input tokens may be full-parallelly fetched. Also, the total number of BLs needs to be greater than D×WBP (weight-bit-precision). Through this, multi-bit weights may be stored and computed at independent BLs.

Second, for the SRAM-PiM array, the number of WLs needs to be sufficiently secured to handle D/H=dₖ dimensions, and H independent arrays are required to handle multi-head projections. Columns of SRAM need to store N weight features, so N×IBP (input-activation-bit-precision) BLs are required.

Meanwhile, to ensure a stable, error-free computation in the AMS-PiM device, the present disclosure limits it to SAWL≤8. Here, that 6-σ error-free computation is possible is verified by Monte-Carlo simulation using AMS-PiM arrays, and the results are summarized in FIG. 7B. This configuration ensures computation close to lossless computation, however, for addressing the aforementioned latency issue, the present disclosure proposes a fast, accurate, and efficient BitSift-GEMV method in section (4) described below.

### (2) Dequantization-Free PTQ Technique

This section proposes the dequantization-free PTQ technique that penetrates all computations within the attention layer, fully eliminates FP and division operations, and also maintains accuracy. As described above, the quantization method proposed herein enables lossless integer quantization using only shifting and parsing, which satisfies important attributes discussed in section 2.

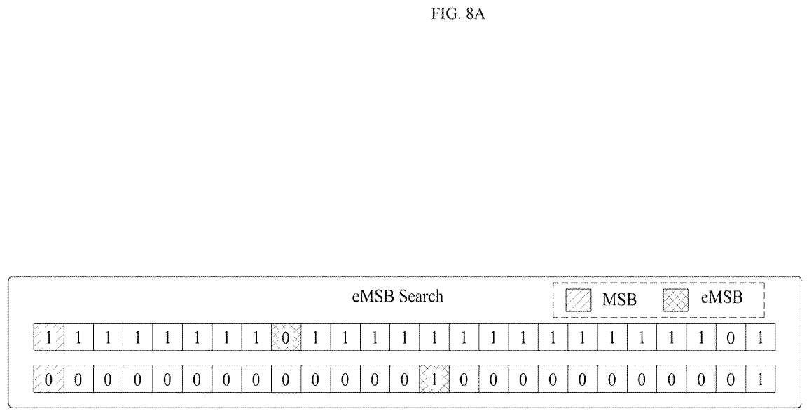

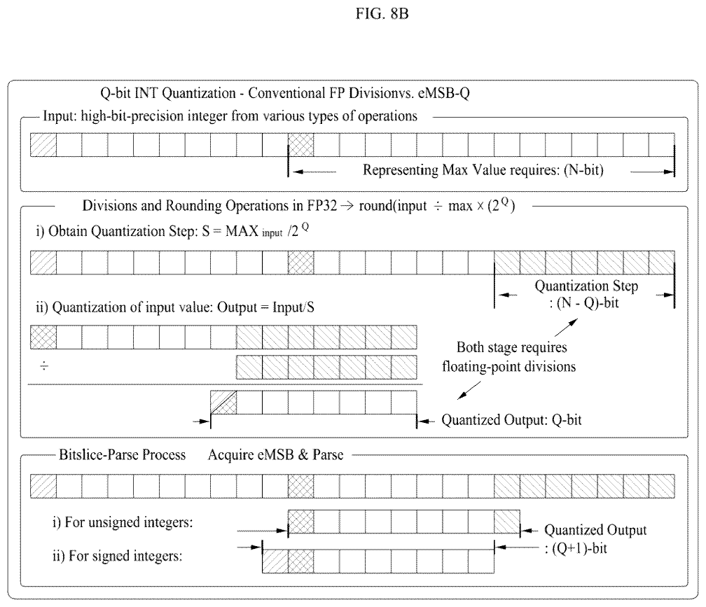

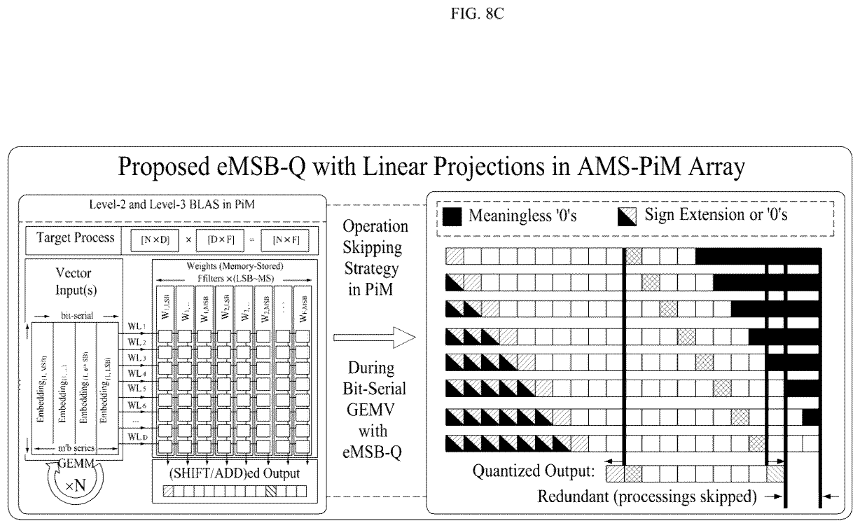

FIGS. 8A, 8B, and 8C illustrate an FP- and division-less integer quantization method according to the present disclosure.

As described above in (1) of section 3, a condition to make integer quantization “lossless” is satisfying [Equation 3] above, which is established when quantization step size S is smaller than that used in FP-based quantization. This implies that the original input may be divided by any 2ⁿ, as long as 2ⁿ<S.

Based on this attribute, the present disclosure decided to eliminate a dequantization and division process compared to the conventional method, as shown in FIGS. 8A and 8B. The method of the present disclosure is called effective-MSB-based quantization (eMSBQ), and ensures numerical integrity while replacing a dequantization and quantization step acquisition process with effective-MSB (eMSB) detection and replacing division operations with arithmetic shifting and parsing. The eMSB-search process simply performs a task of identifying a bit at which an actual MSB is located within a group of bitwise values. Here, sorting to determine the maximum “value” and its “index” is not required.

To prevent outliers from being clipped during the eMSB-Q process, the present disclosure applies per-token quantization to Q, QK^{T}, and the final output. This approach leverages the characteristic that each token vector in Q-matrix is independently processed throughout the self-attention mechanism. On the other hand, KV generation needs to preserve global context, so needs to store all N token vectors. It differentiates the parsing strategy. Parsing starts from MSBs rather than eMSBs using a longer bit, and the wider dynamic range is secured for the global context.

Meanwhile, eMSB-Q preserves the inherent quality, that is, linearity, of linear operation as is. However, to preserve the distinct attribute of a nonlinear layer, the present disclosure transfers eMSB information detected during the per-token quantization process to the VDR-softmax block, such that softmax may reflect exponent information during the processing process. This is essential since the softmax layer relies on accurate exponent handling, unlike a linear layer. In the following section, integer-processed softmax that operates in a PTQ environment is described in more detail.

(3) VDR-Softmax Fused with eMSB-Q

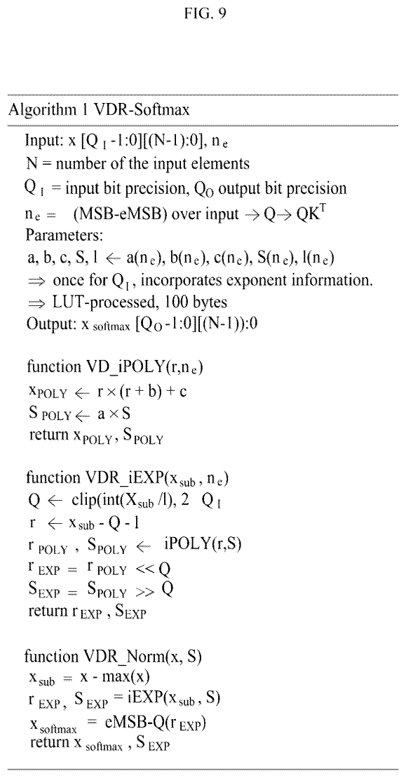

FIG. 9 illustrates a VDR-softmax implementation algorithm according to the present disclosure.

To simplify and accurately implement the softmax layer in PTQ, precise understanding of operation characteristics of softmax and a more sophisticated integer-processing technique are required. This implementation process includes a plurality of key stages summarized in Algorithm 1 of FIG. 9. The method of the present disclosure utilizes per-token eMSB information to ensure accurate, FP-less processing and converts score into an integer format using only shifting and parsing of integers for normalization and quantization.

Although it is very important to preserve exponent information in processing the nonlinear layer (see FIG. 3C), directly multiplying or dividing integer x may make the number exceed the representable range of integers with the designated bit-precision, which may lead to loss of information. The key to handle softmax only with integer arithmetic lies in not directly performing the exponent adjustment for the integer x, while approximating the e^{x/n} function for the integer input value x and n that represents the exponent. To accomplish this, the present disclosure employs a method of adjusting the base (e) of the exponential function. That is, instead of adjusting the integer x, the present disclosure indirectly reflects the exponential term by changing the base (e) to n√e. This method allows the exponential term to be effectively handled without departing from the integer representation range. Also, using e^{x} exponential approximation widely used in the existing studies, this operation is implemented by modifying only internal parameters of the method of the present disclosure. In this process, division arithmetic is not required.

Also, the base adjustment, that is, conversion from e to n√e, performed during the exponentiation process is performed per token using eMSB information acquired from the eMSB-Q stage. Since softmax is computed per token and aligned with the quantization method ((2) of section 3) and the dataflow control mechanism ((5) of section 3) of the present disclosure, there is no need to store eMSB positions for all Q vectors. This significantly enhances scalability of the architecture.

After the exponentiation is completed, the utilization of the dynamic range provided by a Qo-bit (softmax output precision) integer is maximized by applying eMSB-Q to an exponentiation output group generated for each token again. This approach preserves the original proportions of values without division and ensures that the maximum value is mapped to the highest possible integer representation, while securing the sufficient range for smaller values.

As a result, proposed VDR-softmax simultaneously achieves both efficiency and accuracy, so is suitable for end-to-end integer-based acceleration within the PTQ-based attention accelerator architecture. This approach not only retains the critical intrinsic property of exponentiation and division in softmax, but also alleviates computational overhead, leading to significantly improving efficiency and stably ensuring performance.

### (4) BitSift-GEMV Processor

In an end-to-end on-device self-attention layer fusion process, the BitSift-GEMV technique of the present disclosure significantly improves sparse GEMV execution performance in AMS-PiM, which constitutes most of computations in the attention layer. BitSift-GEMV is designed based on the following two key factors: \textcircled{1} the highlighted bitwise sparsity of activation data illustrated in FIG. 5, and \textcircled{2} WL activation (SAWL) having the constant number of “1”s (=8), which maximizes the utilization rate and the robustness of the ADC design.

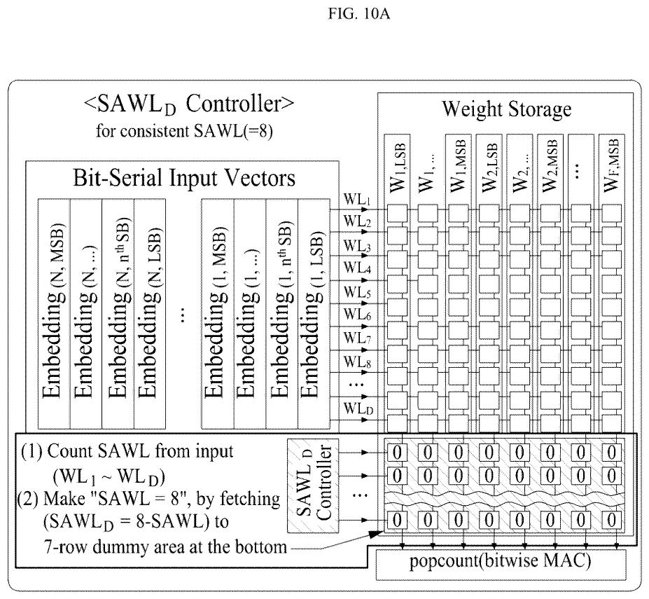

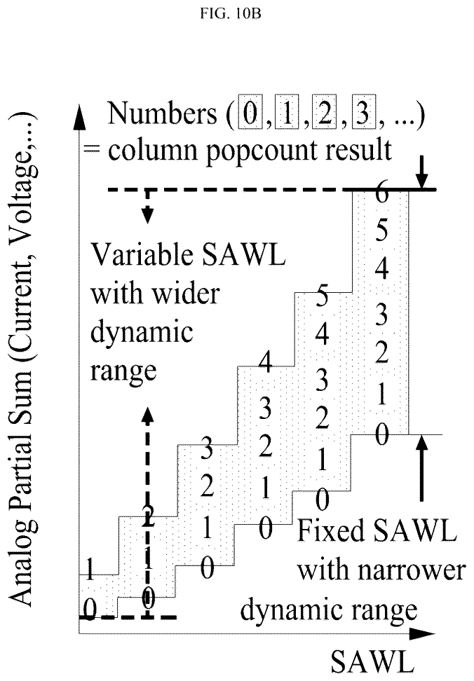

FIGS. 10A and 10B illustrate a SAWL_{D} controller according to the present disclosure.

The existing AMS-PiM designs require flexibility in the number of processible SAWL since input vectors have a random number of “1”s along the bit-slice. However, as illustrated in FIG. 10B, this SAWL flexibility may increase the overhead of the ADC design and may degrade the computation reliability. In the SAWL-flexible design, ADCs need to handle wider and variable dynamic input range, higher resolution, and varying threshold, which decreases the stability of analog-to-digital conversion. Also, when actual SAWL is low, power/area implemented for higher SAWL is wasted and the utilization rate decreases. Therefore, the design of the present disclosure maintains “SAWL=MAX” at all times without allowing flexibility. To this end, dummy “1” inputs are incorporated to activate the fixed maximum number of “1”s per cycle.

To maintain the number of SAWL at 8 (=maximum SAWL that may ensure 6-σ reliability) at all times, the SAWL_{D} controller shown in FIG. 10A supplements SAWL with additional “1” when the number of “1”s included in input vector is less than 8. Specifically, the SAWL_{D} controller activates SAWL_{D}=(8−SAWL) WLs at the bottom of the array. To this end, a dummy array and WL interfaces including seven dummy rows are included at the bottom of the array. Memory cells within these dummy rows are all set to “0” (off-cell), emulating the same effect as dummy inputs. This array configuration serves two purposes: \textcircled{1} isolation of dummy operations, which prevents the dummy array from affecting the actual computation output, and \textcircled{2} enhancement of variation resiliency in which the dummy array consistently returns “0” and the system becomes more robust against PVT variations. That is, only the term corresponding to “1”s along the input vector is used for the actual computation and bitwise “0”s are automatically skipped from the actual computation.

SAWL_{D} controller-based processing that maintains the fixed SAWL employs two-step approach. First, the input vector is scanned to identify the longest slice including eight “1”s, and the slice is selected for processing. Second, when the number of “1”s is insufficient at the tail end of the vector or when the input vector is very sparse, the SAWL_{D} processor supplements the additional “1”s to the dummy array to fill the SAWL. Through this, SAWL=8 may be consistently maintained for all computations regardless of density of the input vector. If the SAWL is fixed, the dynamic range of input to be processed by ADCs is consistently maintained, which results in reducing area/energy/error overhead.

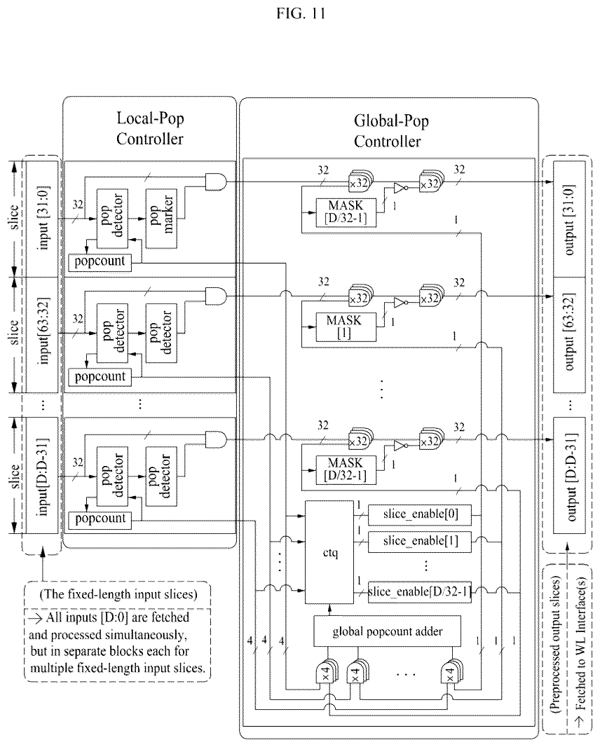

FIG. 11 illustrates a BitSift-GEMV controller according to the present disclosure.

To support the SAWL_{D} controller by identifying the longest segment of input that includes the largest number of “1”s, while maintaining the constraint of SAWL≤8, the present disclosure introduces the BitSift-GEMV controller as illustrated in FIG. 11. This strategy introduces a novel approach for highly efficient sparse GEMV processing, and achieves low latency and minimum area/energy overhead. A hypothetical brute-force method, which is a method of scanning the entire input vector bit by bit, increases latency according to the increase in the vector length and sparsity. In contrast, the BitSift-GEMV controller solves this by utilizing a hierarchical structure with high parallelism. This structure includes the following two modules: a local-pop controller (LPC) and a global-pop controller (GPC). Here, “pop-count” refers to the number of “1”s within the input vector.

\textcircled{1} The LPC divides the input vector into short and fixed-length slices and then quickly counts the number of “1”s using dedicated “pop detector” and “popcount” blocks for each slice. Owing to this localized processing method, the popcount within each slice may be computed with very short latency.

\textcircled{2} The GPC aggregates popcounts transferred from a plurality of LPCs and quickly identifies a segment that includes the largest number of “1”s, without exceeding a constraint value, 8. Once aggregation is complete, the GPC activates MASK to deliver the corresponding vector to the output and WLs. If the total number of “1”s identified by the GPC is less than 8, the SAWL_{D} controller shown in FIG. 10A supplements the input with “1”s from the dummy array before forwarding the same to WLs of PiM array and fills the SAWL. This hierarchical and parallel architecture enables the AMS-PiM array of the present disclosure to continuously maintain high performance although the input vector length and sparsity increase. In particular, the popcount within each LPC slice is 8 or less, which is optimized for extremely sparse input. This well aligns with the activation value distribution of the actual neural network as illustrated in FIGS. 5E and 5F.

However, since real-world data may exhibit varying sparsity patterns, the BitSift-Controller additionally includes dedicated circuitry to handle dense input segments. That is, the BitSift-GEMV controller dynamically adjusts the processing flow when the LPC encounters eight or more “1”s within a single slice or when the GPC detects a global popcount exceeding 8. This dynamic adjustment mechanism is as follows. When the “pop detector” block within the LPC detects eight “1”s before reaching the end of the sliced input, a “pop marker” block marks a section ranging from a beginning point of the input to a point at which an eighth “1” is found. The marked section is fetched first from the AMS-PiM array and processed, consuming a column-sum cycle. Then, the marker marks an area to be processed next among remaining input sections not processed so far, which is repeated until the process reaches the end of an input slice processible by the LPC. After the LPC-level sparsity requirement (popcount <8) is met, when a global popcount adder returns a value exceeding 8 in the GPC, a compute-token queue (ctq) circuit block controls a “MASK” signal. Through this, the input fetch of the LPC may be gated such that the LPC of which popcount sum is less than 8 may fetch the input to the PiM array. When the input vector length is [D], this processing method requires processing cycles up to roundup

$$( \frac{D \times ( 1 - bitwise\_sparsity )}{8} ) .$$

Therefore, the BitSift-GEMV technique may reduce the overall processing latency by (1−bitwise_sparsity). This method fully utilizes the fine-grain of sparsity.

### (5) Reduced Tensor Traffic

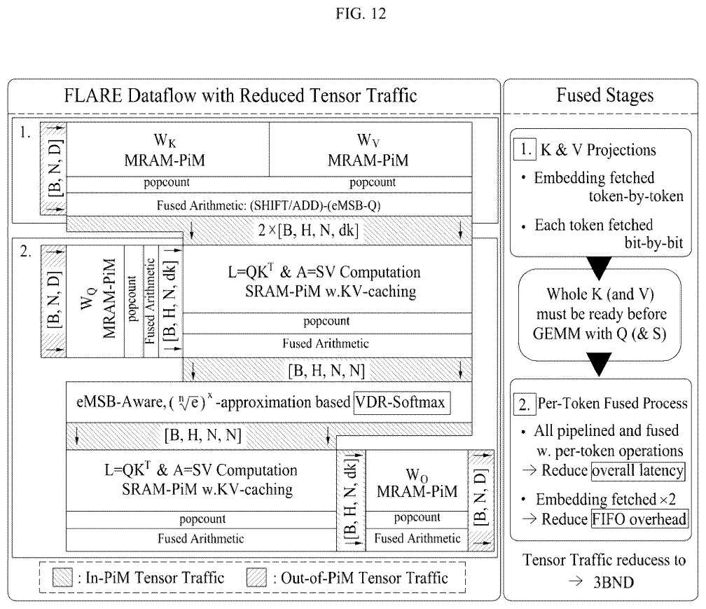

FIG. 12 illustrates FLARE data flow and tensor traffic according to the present disclosure.

Conclusively, the FLARE architecture minimizes tensor traffic within the attention mechanism through the end-to-end attention layer fused with a plurality of innovative techniques. The dataflow of the FLARE architecture presented in FIG. 12 may be understood as the following two stages: \textcircled{1} K & V projection stage, and \textcircled{2} end-to-end fused, per-token (Q-L-A-O) process.

\textcircled{1} K & V projection: This stage involves A-W GEMM (=a series of GEMV) operations on input tokens using weight matrices W_{K} and W_{V}. To this end, input streaming is required and the complete KV matrices are generated through this process.

\textcircled{2} Per-token fused process: After generating KV matrices, the end-to-end-fused attention process is performed. To this end, a second input stream is required. Rather than storing input in an internal buffer, a method of performing streaming twice is adopted to improve area efficiency and scalability.

Therefore, the revised tensor traffic may be represented as follows. This is the result of achieving a substantial reduction in tensor traffic compared to the existing techniques by utilizing the proposed techniques.

$$Revised Tensor Traffic = 2 \times B \times N \times D ( in ) + B \times N \times D ( out ) \qquad [ Equation 6 ]$$

In short, the core configuration of the present disclosure is to accurately implement quantization without floating-point-based operation and division, which are considered essential for quantization in the case of post-training quantization (PTQ). The quantization technique, called eMSB-Q of FIGS. 8B and 8C, explains the core of the technique of the present disclosure. In the process of quantizing a bundle of numbers having an integer representation system, quantization is performed by finding the eMSB with a “substantial” meaning by parsing from the corresponding bit position to a position of a one bit longer than the originally intended bit length.

The present disclosure offers two major technical advantages. First, the present disclosure replaces a sorting algorithm/hardware used in conventional methods. Instead of finding input_{MAX} through a sorting method, a bit in which representation of 1111 . . . or 0000 . . . is first reversed is simply found from the entire input bundle and only an eMSB position is found and handled instead of identifying a corresponding number as which index. Second, a complex process of dividing the maximum value by 2ⁿ to obtain S, then dividing the input bundle again after obtaining S, and then rounding to an integer (referred to as dequantization-quantization or fake-quantization) is replaced with a very simple method that does not require division, simply performing truncation using one more bit.

This technology may achieve the accurate computational results while handling various operations in a simple manner as described above, which is attributed to the accurate understanding of the number representation system and the quantization process.
In the process of processing integer quantization, when specific inputs x1 and x2 are quantized to Q(x1) and Q(x2), performing accurate quantization implies maintaining Q(x1)/Q(x2) as when performing accurate division based on floating point. Qualitatively, the same performance may be maintained as long as the ratio of each number is the same regardless of a quantization method (since quantization inevitably causes information loss, this does not indicate similarity to the ratio of the original number: x1/x2).
This technique has a ratio between quantized outputs that is comparable to quantization of processes floating points.
Basically, for most values, truncation without using an extra bit may maintain a similar ratio. However, to maintain a ratio that is exactly identical or more similar to a ratio between original input values, an extra bit needs to be used as described above. While the method of using an extra bit accompanies large efficiency degradation when communication outside a device (e.g., CPU-Memory) is required, this technique may allow the quantization technique to be on-device by eliminating floating-point processing or division, and in view of other benefits, using an extra bit on-device may be a very small addition compared to floating-point/division processing.

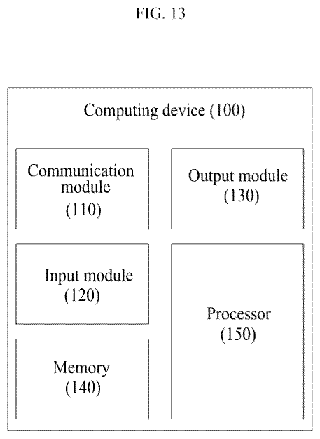

FIG. 13 is a diagram illustrating a computing device 100 according to the present disclosure.

Referring to FIG. 13, the computing device 100 is provided for bit-shift and parsing-based quantization for eliminating floating-point and division processing for efficient post-training quantization (PTQ), that is, may be implemented to utilize the aforementioned FLARE. Specifically, the computing device 100 may include at least one of a communication module 110, an input module 120, an output module 130, a memory 140, and a processor 150. In some example embodiments, at least one of the components of the computing device 100 may be omitted, and at least one another component may be added. In some example embodiments, at least two of the components of the computing device 100 may be implemented as a single integrated circuit. Here, the components of the computing device 100 may be configured to be integrated within a single housing, or may be configured to be distributed within a plurality of housings.

The communication module 110 may perform communication with an external device in the computing device 100. The communication module 110 may establish a communication channel between the computing device 100 and the external device and may perform communication with the external device through the communication channel. The communication module 110 may include at least one of a near field communication module and a far field communication module. The near field communication module may communicate with the external device using a near field communication method.

The input module 120 may input a signal to be used for at least one component of the computing device 100. The input module 120 may be configured to detect a signal directly input from a user or to generate a signal by detecting an ambient change. For example, the input module 120 may include at least one of a mouse, a keypad, a microphone, and a sensing module having at least one sensor. In some example embodiments, the input module 120 may include at least one of touch circuitry configured to detect a touch and sensor circuitry configured to measure intensity of force generated by the touch.

The output module 130 may output information to the outside of the computing device 100. The output module 130 may include at least one of a display module configured to visually output information and an audio output module that may output information as an audio signal. For example, the audio output module may include at least one of a speaker and a receiver.

The memory 140 may store a variety of data used by at least one component of the computing device 100. For example, the memory 140 may include at least one of a volatile memory and a nonvolatile memory. Data may include at least one program and input data or output data related thereto. The program may be stored as software that includes at least one instruction in the memory 140, and may include at least one of an operating system (OS), middleware, and an application.

The processor 150 may control at least one component of the computing device 100 by executing the program of the memory 140. Through this, the processor 150 may perform data processing or operations. Here, the processor 150 may execute an instruction stored in the memory 140.

Specifically, the processor 150 may detect a bit of a position at which a value varies in a bitstring of a plurality of input values that are input in a bit-serial form as an effective most significant bit, that is, an eMSB. That is, the effective most significant bit may be a bit having a value different from a value of a preceding bit in the bitstring. The processor 150 may define a parsing section of a target bit count based on the effective most significant bit. The parsing section may start from the effective most significant bit. In an example embodiment, the parsing section may have a bit width that matches the target bit count. In another example embodiment, the parsing section may have a bit width that is one-bit wider than the target bit count. Here, the parsing section may be a bit slice for normalizing the dynamic range of the input values of the bit serial to an integer scale of 2ⁿ form. Also, the processor 150 may perform post-training quantization, that is, PTQ by applying arithmetic shift to the parsing section. Specifically, the processor 150 may generate quantization outputs of input values of the bit serial. Here, a ratio of the quantization outputs may be maintained to be the same as that of floating-point-based quantization outputs for the input values. As a result, floating-point and division processing for the post-training quantization may be eliminated.

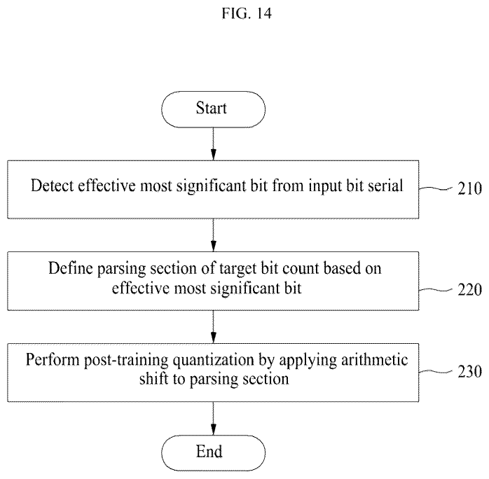

FIG. 14 is a flowchart illustrating an operating method of the computing device 100 according to the present disclosure.

Referring to FIG. 14, in operation 210, the computing device 100 may detect an effective most significant bit, that is, an eMSB from an input bit serial. Specifically, a bitstring of a plurality of input values may be input in a bit-serial form. In response thereto, the processor 150 may detect a bit of a position at which a value varies in the bitstring as the effective most significant bit. That is, the effective most significant bit may be a bit having a value different from a value of a preceding bit in the bitstring. For example, when two consecutive bits in the bitstring have values of ‘0’ and ‘1’, respectively, a subsequent bit having the value of ‘1’ may be detected as the effective most significant bit. Alternatively, when two consecutive bits in the bitstring have values of ‘1’ and ‘0’, respectively, a subsequent bit having the value of ‘0’ may be detected as the effective most significant bit.

In operation 220, the computing device 100 may define a parsing section of a target bit count based on the effective most significant bit. Specifically, the, processor 150 may define the parsing section that starts from the effective most significant bit. In an example embodiment, the parsing section may have a bit width that matches the target bit count. In another example embodiment, the parsing section may have a bit width that is one-bit wider than the target bit count. Here, the parsing section may be a bit slice for normalizing the dynamic range of the input values of the bit serial to an integer scale of 2ⁿ form. Here, n denotes an integer exponent that determines the integer scale.

In operation 230, the computing device 100 may perform post-training quantization, that is, PTQ by applying arithmetic shift to the parsing section. Specifically, the processor 150 may generate quantization outputs of the input values. Here, a ratio of the quantization outputs may be maintained to be the same as that of floating-point-based quantization outputs for the input values. For example, the processor 150 may compute a shift amount within the parsing section and then may apply the arithmetic shift corresponding to the shift amount within the parsing section. Here, the processor 150 may perform 2ⁿ-based normalization. As a result, floating-point and division processing for the post-training quantization may be eliminated.

Accordingly, the present disclosure may achieve dequantization-quantization, that is, fake-quantization removal and increased hardware efficiency. eMSB-Q may eliminate the conventional quantization, that is, dequantization-quantization process, and may perform operations through eMSB detection, arithmetic shifting, and parsing. Through this, by eliminating reliance on a floating-point unit (FPU) and a high-ENOB analog-to-digital converter (ADC), complexity and power consumption of hardware design may be significantly reduced.

The present disclosure may ensure high accuracy by maintaining a numerical ratio. By implementing quantization that maintains a ratio based on eMSB of input data, precision with the same ratio as floating-point (FP)-based quantization may be provided. Using an additional bit in this process may guarantee numerical stability while maintaining computational accuracy.

The present disclosure enables efficient computation through bitwise sparsity. eMSB-Q may maximize the computational efficiency by processing data at the bit level. In particular, by effectively utilizing bitwise sparsity that frequently occurs in a deep neural network (DNN), it is possible to reduce a required computational amount and to increase a speed.

The present disclosure may maintain exponent information of a nonlinear layer. eMSB-Q may efficiently maintain exponent information required in a nonlinear layer (e.g., softmax) and may replace divisions with arithmetic shifting. This may minimize hardware burden while maintaining the existing computational accuracy.

The present disclosure may demonstrate improved robustness against process, voltage, temperature (PVT) errors. eMSB-Q is designed with low-ENOB instead of using a high-ENOB ADC, thereby reducing computational errors due to PVT variations and providing a stable computational environment.

The present disclosure may provide a design optimized for a transformer model. It may perform core operations in the transformer-based model (e.g., query/key/value (Q/K/V) generation, direct operations with quantized data in self-attention), thereby improving energy efficiency while maintaining model accuracy.

The aforementioned methods may be provided in a computer program stored in computer-readable media to be executed on a computer. Here, the media may be to continuously store a computer-executable program or to temporarily store the same for execution or download. Also, the media may be various types of recording methods or storage methods in which single hardware or a plurality of hardware is combined and may be distributed over a network without being limited to a medium that is directly connected to a computer system. Examples of the media include a ROM, a PROM, an EPROM, an EEPROM, a flash memory (e.g., NAND/NOR), an SSD, a HDD, a magnetic tape, optical media (CD-ROM, DVD, and BD), magneto-optical media, a memory card, and a USB memory. The media refers to non-transitory media, and does not include a transmission signal itself or purely volatile memory (e.g., RAM).

The methods, operations, or techniques of the present disclosure may be implemented in various manners. For example, the techniques may be implemented by hardware, firmware, software, or combinations thereof. Those skilled in the art may understand that various exemplary logical blocks, modules, circuitries, and algorithm operations described in association with the disclosure herein may be implemented using electronic hardware, computer software, or combinations thereof. To clearly describe this interchangeability between hardware and software, various exemplary components, blocks, modules, circuitries, and operations are described above in terms of functions thereof. Whether such functions are implemented as hardware or implemented as software depends on design requirements imposed on the overall system and a specific application. Those skilled in the art may implement the aforementioned functions in various manners for each specific application, but such implementations should not be interpreted as deviating from the scope of the present disclosure.

In hardware implementation, processing units used to perform the techniques may be implemented using one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, computer, or combinations thereof.

Therefore, various exemplary logic blocks, modules, and circuitries described in association with the present disclosure may be implemented or performed in any combination with a general-purpose processor, a DSP, an ASIC, an FPGA, or other programable logic devices, a discrete gate or a transistor logic, discrete hardware components, or devices designed to perform functions described herein. The general-purpose processor may be a microprocessor and, alternatively, the processor may be a conventional processor, a controller, a microcontroller, or a state machine. The processor may be implemented using a combination of computing devices, for example, a combination of a DSP and a microprocessor, a combination of a plurality of microprocessors, a combination of one or more microprocessors associated with a DSP core, and a combination of other components.

In firmware and/or software implementation, the techniques may be implemented as instructions stored in computer-readable recording media, such as a random access memory (RAM), a read-only memory (ROM), a non-volatile random access memory (NVRAM), a programmable read-only memory (PROM), an erasable programmable read-only memory (EPROM), an electrically erasable PROM (EEPROM), a flash memory, a compact disc (CD), and a magnetic or optical data storage device. The instructions may be executable by one or more processors, and may cause the processor(s) to perform specific aspects of the functions described herein.

Although the example embodiments are described as using aspects of the currently disclosed subject matter in one or more stand-alone computer systems, the present disclosure is not limited thereto and may be implemented in conjunction with an arbitrary computing environment, such as a network or a distributed computing environment. Also, aspects of the subject matter in the present disclosure may be implemented in a plurality of processing chips or devices, and a storage may be similarly affected across the plurality of devices. The devices may include PCs, network servers, and portable devices.

Although the present disclosure is described with reference to some example embodiments, various modifications and changes may be made without departing from the scope of the present disclosure that may be understood by those skilled in the art. Also, such modifications and changes should be understood to fall within the scope of the claims.

What is claimed is:

1. An operating method of a computing device, the method comprising:
detecting a bit of a position at which a value varies in a bitstring of a plurality of input values that are input in a bit-serial form as an effective most significant bit (eMSB);
defining a parsing section of a target bit count based on the effective most significant bit; and
performing post-training quantization (PTQ) by applying arithmetic shift to the parsing section.

2. The method of claim 1, wherein the effective most significant bit has a value different from a value of a preceding bit in the bitstring.

3. The method of claim 1, wherein the parsing section starts from the effective most significant bit.

4. The number of claim 1, wherein the parsing section has a bit width that matches the target bit count.

5. The method of claim 1, wherein the parsing section has a bit width that is one-bit wider than the target bit count.

6. The method of claim 1, wherein the performing of the post-training quantization by applying the arithmetic shift to the parsing section comprises generating quantization outputs of the input values, and
a ratio of the quantization outputs is maintained to be the same as floating-point-based quantization outputs for the input values.

7. The method of claim 1, wherein the parsing section is a bit slice for normalizing the dynamic range of the input values to an integer scale of 2ⁿ form where n denotes an integer exponent that determines the integer scale.

8. The method of claim 1, wherein floating-point and division processing for the post-training quantization are eliminated.

9. A computing device comprising:
a memory; and
a processor configured to connect to the memory, and to execute at least one instruction stored in the memory,
wherein the processor is configured to,
detect a bit of a position at which a value varies in a bitstring of a plurality of input values that are input in a bit-serial form as an effective most significant bit (eMSB),
define a parsing section of a target bit count based on the effective most significant bit, and
perform post-training quantization (PTQ) by applying arithmetic shift to the parsing section.

10. A non-transitory computer-readable recording medium storing a computer program to execute a post-training quantization method on a computing device, wherein the post-training quantization method comprises:
detecting a bit of a position at which a value varies in a bitstring of a plurality of input values that are input in a bit-serial form as an effective most significant bit (eMSB);
defining a parsing section of a target bit count based on the effective most significant bit; and
performing post-training quantization (PTQ) by applying arithmetic shift to the parsing section.
